(19) United States
(12) Patent Application Publication
(10) Pub. No.: US 2014/0276267 A1
(43) Pub. Date: Sep. 18, 2014

(54) Orthotic Load Assistance Device

(71) Applicant: BAE Systems Aerospace & Defense Group Inc., Phoenix, AZ (US)

(72) Inventor: Adarsh Ayyar, Paradise Valley, AZ (US)

(73) Assignee: BAE Systems Aerospace & Defense Group Inc., Phoenix, AZ (US)

(21) Appl. No.: 14/138,439

(22) Filed: Dec. 23, 2013

Related U.S. Application Data
(60) Provisional application No. 61/790,259, filed on Mar. 15, 2013.
(60) Provisional application No. 61/790,970, filed on Mar. 15, 2013.

(51) Int. Cl. A61H 3/00

(52) U.S. Cl. CPC A61H 3/00
USPC 601/35

(57) ABSTRACT

A load assistance device in which the soldier moves the device, not vice versa, includes a load receptor for receiving load from the mass; a boot clamp for transmitting the load to the user's boot; and a linkage connected between the load receptor and the boot clamp, the linkage having an actuated condition in which the linkage transmits load downward from the load receptor into the boot clamp and having an unactuated condition in which the linkage does not transmit load downward from the load receptor into the boot clamp. At least one sensor senses the user's stride. A computer is responsive to the sensor for controlling movement of the linkage between the actuated and unactuated conditions. The linkage is moved into the actuated condition upon sensing of the commencement of the stance phase of the user's stride and is moved into the unactuated condition in response to sensing of the heel lift phase of the user's stride.

### RELATED APPLICATIONS

This application claims the benefit of U.S. Provisional Application No. 61/790,259, filed Mar. 15, 2013, U.S. Provisional Application No. 61/790,970, filed Mar. 15, 2013; and U.S. Nonprovisional application Ser. No. 13/767,945, filed Feb. 15, 2013; and incorporates by reference all their subject matter.

### BACKGROUND OF THE INVENTION

The invention relates to a load carrying device that transmits load from a weight being carried on a user's back, to the ground that the user is walking on. One instance of such use is a soldier wearing a backpack; in some cases, the backpack can weigh eighty pounds or more, and relieving some of the load can benefit the soldier significantly.

As the soldier walks forward he takes strides sequentially with each foot. Each stride has a swing phase in which the foot is off the ground; a heel strike phase in which the heel of the foot strikes the ground and the forefoot moves down toward the ground; a plant phase in which the foot is on the ground, including a rollover phase in which the ankle is rolling forward; and a lift-off phase in which the foot lifts off the ground, heel first and then forefoot, moving back into the swing phase of the stride.

The load carried by the soldier is transmitted to the ground by one leg and then the other, during that part of each stride whenever at least a portion of the foot is on the ground. In light of the sometimes heavy load carried by the soldier, it would be desirable to relieve some of that load.

### BRIEF DESCRIPTION DRAWINGS

Features and advantages of the invention will become apparent to one of ordinary skill in the art to which the invention pertains by a reading of the following description together with the accompanying drawings, in which:

FIG. 1 is a schematic illustration of a soldier using a load assistance device that is a first embodiment of the invention;

FIG. 2 is a side elevational view of the load assistance device of FIG. 1, excluding the ankle mechanism;

FIG. 3 is an enlarged view of the ankle mechanism portion of the load assistance device;

FIG. 4 is another enlarged view of the ankle mechanism;

FIG. 5 is a side elevational view of the load assistance device, shown in a swing phase of the user's stride;

FIG. 5A is an enlarged view of a portion of FIG. 5;

FIG. 6 is a side elevational view of the load assistance device, shown in a heel strike phase of the user's stride;

FIG. 6A is an enlarged view of the load assistance device;

FIG. 7 is a side elevational view of the load assistance device, shown in a rollover phase of the user's stride;

FIG. 7A is an enlarged view of a portion of FIG. 6;

FIGS. 8 and 9 show the ankle mechanism in a lift-off phase of the user's stride; and

FIGS. 10 and 11 illustrate schematically some forces generated by use of the load carrying device.

### DETAILED DESCRIPTION

The invention relates to a load carrying device that transmits load from something being carried on a user's back, to the ground that the user is walking on. More specifically the invention relates to a device that transmits load downward from a weight, such as a backpack, to the ground under a soldier's boot. (The term “soldier” is used herein to refer to the user of the load carrying device of the invention; the invention can be used by persons other than soldiers per se, and loads other than backpacks can be carried.) The invention is applicable to load carrying devices of varying and different constructions. As representative of the invention, FIG. 1 illustrates a load carrying device 10 that is a first embodiment of the invention. A similar device 11 used on the other leg, and is a mirror image (lateral-medial) of the device 10.

The load carrying device 10 includes a load receptor point illustrated schematically at 12, located at or near the top of the device. The load receptor point 12 is the portion of the device 10 at which the device connects with the backpack 14 or other load being carried, and receives the gravitational load of the backpack. The load receptor 12 can take any form suitable for connection with the load 14 to be supported. For example, it may include portions that mechanically connect with a frame (not shown) of the backpack 14.

The device 10 includes an upper arm 16 extends downward and forward from the load receptor 12 to a knee joint 18. The upper arm 16 is a rigid, fixed-length member that carries a small amount of load but is primarily a stabilizing member.

An actuator arm 20 also extends between the load receptor 12 and the knee joint 18, generally in parallel with the upper arm 16. The actuator arm 20 is a member that is controlled to selectively transmit (or not) the remainder of the load between the load receptor 12 and the knee joint 18.

In the illustrated embodiment, which is not intended to be limiting, the actuator arm 20 includes a “jack spring” 22, a device as shown for example in U.S. Pat. Nos. 7,527,253 and 7,992,849, the entire disclosures of which are hereby incorporated by reference. The jack spring 22 is a load transmitting member with a compression coil spring 24 at its upper (load receptor) end and a projecting rod 26 at its lower (knee joint) end. The actuator arm 20 effectively has a variable length, as described below.

The jack spring 22 is configured to provide a gap between the lower end of the spring 24 and the upper end of the rod 26, which gap can be selectively opened and closed. To this end, the actuator arm includes a motor 28 for selectively changing the effective length of the spring 24, and for selectively closing or opening the gap between the spring and the rod 26. This action is provided by an actuating tab (not shown) on the end of an inner shaft that rotates when the motor 28 is energized. The actuating tab is captured between two adjacent coils of the spring 24.

The gap in the jack spring 22 is produced by moving the spring 24 bodily toward and away from the rod 26. The spring 24 is moved axially by energizing the motor 28 and rotating the inner shaft and thus the actuating tab, causing the spring (which translates freely on the inner shaft but is blocked from rotation) to be moved bodily, axially.

In operation of the load carrying device 10 (described below) the motor 28 is periodically energized in a first direction of rotation to cause the spring 24 to be moved bodily toward the rod 26 to close the gap, and is then energized in a second direction of rotation to cause the spring to move away from the rod to open the gap. Thus, this portion of the jack spring 22 acts as a clutch, opening and closing, as set forth in the patents noted above.

The load carrying device 10 also includes a leg 40, which in the illustrated embodiment is a rigid cylindrical tube. The leg 40 extends downward from the knee joint 18 to an ankle joint 42. The knee joint 18 is a connection enabling pivotal movement between the upper arm 10, the actuator 20, and the leg 40. The ankle joint or ankle mechanism 42 (described below in more detail) is a connection enabling pivotal movement between the leg 40 and a boot clamp 44 that is the lowermost portion of the device 10.

The boot clamp 44 is an element that is connected to the soldier's boot 46, for movement with the soldier's boot. As a result of this placement of the boot clamp 44, any vertical load that is transmitted down through the device 10 to the boot clamp 44, is transmitted to the boot 46 and then to the ground under the soldier's boot, at the location of the soldier's boot.

One or more sensors on the human leg (shown schematically at 47) sense the rate of change of the angle of the human leg relative to vertical or horizontal), in a known manner. The output of the sensors 47 is fed into a microprocessor (computer) 48 adjacent the motor 28, that is programmed to take that information and determine where the soldier currently is, in the gait cycle or stride.

The computer 48 controls operation of the motor 28 of the actuator arm 20. Specifically, the load is transmitted down from the receptor 12 through the actuator 20, the knee joint 18, the leg 40, and the ankle joint 42, to the boot clamp 44. When the computer 48 determines that the soldier's foot is off the ground but about to strike the ground, the computer energizes the motor 28 to close the gap between the spring 24 and the rod 26. This closes the load transmission path in the actuator 20, making the actuator a force-transmitting member along its length. Thus, when the soldier's heel strikes the ground, load from the backpack 14 can be transmitted along the length of the actuator arm 20, to the knee joint 18 and the leg 40 to the boot clamp 44. This relieves some of the load on the soldier.

For so long as the computer 48 determines that the soldier's foot is on the ground, the jack spring 22 is maintained in this closed or load-transmitting condition, to enable part of the load of the backpack 14 to be transmitted to the boot clamp. When the computer 48 thereafter determines that the soldier is lifting his foot off the ground, the computer energizes the motor 28 to open the gap between the spring 24 and the rod 26. Load can no longer be transmitted between the backpack 14 and the boot clamp 44. This action is taken because, when the soldiers boot is off the ground, by definition no load can be transmitted to the ground; so, there is no reason to transmit any load from the backpack 14 to the boot clamp 44.

The motor 28 is not designed to move any parts of the device 10 (other than internal parts of the jack spring 22) relative to other parts of the device 10, or to move any of the soldier's body parts (leg, etc.). Rather, the sole purpose of the motor 28 is to open and close the gap between the rod 26 and the spring 24. This work does not take much electric power. As a result, the motor 28 can be small and lightweight, and of a low power draw, and the power source for the motor can be small and lightweight. Also, the load carrying device 10 itself does not carry the soldier's body weight, only a portion of the load of the backpack 14, and thus the device itself can be lightweight. The soldier moves the device 10, not the other way around.

The benefits of the use of a jack spring actuator 22 in the device 10 include light weight, settable spring force, and compliance (spring loaded) when the gap is closed. The actuator 20 is compliant in the sense that the spring 24 is a compression spring that can compress and extend in a direction parallel to the length of the actuator arm. Thus, when the gap in the actuator 20 is closed, and force is transmitted through the actuator, the actuator is “spring loaded” for comfort and stability.

In one embodiment, the effective length of the spring 24, and thus the effective spring force in the actuator 20, is changed manually by the operator when he determines that the load (weight of the backpack 14) has changed significantly. In another embodiment, the motor 28 can be used to change the effective length of the spring 24, by actuating the motor to place more coils or fewer coils in action. As an example, one can initially set the actuator 20 to have, for example, six active coils. Then, when the motor 28 is energized, the spring 24 is pushed out by three turns to engage the rod 26, then withdrawn. Or, the spring 24 can be initially set to have five active coils, then pushed out by three turns out to eight and withdrawn back to five. In each case the spring 24 moves by the same in-out distance, only from a different starting point. The different starting point sets the effective spring force, as discussed, for initial setting of weight of load, for changes in load weight along the way, and for terrain changes.

The ankle joint or ankle mechanism 42 connects the device leg 40 to the soldier's boot 46 by means of the boot clamp 44. One embodiment of the ankle mechanism 42 is shown in FIGS. 3 through 11 and is described below in detail.

The boot clamp 44 in the illustrated embodiment is a single piece metal cuff having a generally C-shaped configuration (when viewed from above) that wraps around the heel of the boot 46 and is secured to (clamped onto) the outsole 50 of the boot. The boot clamp 44 extends from the medial side of the boot 46 to the lateral side. In the illustrated embodiment, to secure the boot clamp 44 to the boot 46, several holes are drilled in the outsole 50 of the boot, on either side and at the heel. Internally threaded inserts are then secured in the holes in the outsole 50. The inserts receive suitable fasteners such as screws. The screws extend through openings in the boot clamp 44 that are aligned with and overlie the inserts. The screws thus secure the boot clamp 44 to the boot 46.

The configuration of the boot clamp 44 is beneficial in that it does not have any portions disposed below the outsole 50, that is, between the outsole and the ground. Thus, any interference of the boot clamp 44 with the soldier's stride is minimized. In addition, any boot 46 can be used; the size and shape of the boot clamp 44 are tailored to fit the exact boot. The key area is on the lateral side of the boot 46, where the ankle mechanism 42 attaches to the boot clamp 44; on the medial side of the boot, the boot clamp is simply attached to the outsole 50 of the boot.

The ankle mechanism 42 also includes a block 60 that is fixed to the lateral side of the boot clamp 44. The block 60 in the illustrated embodiment comprises two plates 62 rigidly joined to each other by a plurality of fasteners 64, but the block could take other configurations. The fasteners may also extend through the boot clamp 44 and into the outsole 50. The block 60 defines a forward pivot axis 66 of the ankle mechanism 42 and a back pivot axis 68 of the ankle mechanism.

The ankle mechanism 42 also includes an upper block or tee 70. The tee 70 has a forward leg 72 that extends generally vertically, and a bar 74, fixed for movement with the forward leg 72, that extends rearward, generally horizontally, from the forward leg of the tee.

A front link 76 is fixed for movement with the tee 70. The front link 76 extends downward from the lower end of the forward leg 72 of the tee 70. The front link 76 is a rigid member that is supported on the block 60 for pivotal movement relative to the block about the forward pivot axis 66. As a result, the tee itself 70 is supported on the block 60 for pivotal movement relative to the block about the forward pivot axis 66.

A support pin 80 is fixed to and extends upward from the upper end of the forward leg 72 of the tee 70. The support pin 80 is a rigid member that is fixed for movement with the tee 70. The lowermost portion of the leg 40 of the device 10 is configured as a sleeve 82 that slips over the support pin 80 and that bottoms out on the upper end of the forward leg 72 of the tee 70. By this connection, the leg 40 of the device 10 is supported on (connected with) the block 60 for pivotal movement relative to the block about the forward pivot axis 66.

This slip fit of the sleeve 82 on the support pin 80 constitutes a slip joint 84 that enables the device 10 to be easily disconnected from the soldier's boot 46. In one example, the support pin 80 is about six inches long, and so lifting the sleeve 82 upward by that distance allows the device 10 to be disconnected from the boot clamp 44 and thus from the soldier's boot 46.

In addition, this elimination of any permanent fixed longitudinal connection between the device leg 40 and the ankle mechanism 42 provides for freedom of movement in a vertical direction between the device leg 40, and the soldier's boot 46. The only time there is load transmission is when the sleeve 82 bottoms out on the tee 70. This enables the device 10 to be more comfortable when the soldier is walking; the soldier does not experience significant resistance from the portion of the device below the slip joint 84, when the slip joint is open.

The components of the slip joint 84 and the device leg 40 are configured so that there can be a gap in the slip joint (and thus no vertical force transmission) at all parts of the stride except during the plant phase of the stride. When heel strike occurs (the beginning of the plant phase), the sleeve 82 moves downward sufficiently to close the gap in the slip joint 84 and enable load transmission from the leg 40 to the ankle mechanism 42. The gap stays closed, until the swing phase of the stride commences. The lengths of the sleeve 82 and support pin 80 are selected so that the sleeve does not come off the support pin during normal usage, that is, during a normal stride.

A block link 90 is pivotally connected to the block 60, at the back pivot axis 68. The back link 90 is a rigid member that extends upward from the back pivot axis 68, through a through hole in the distal end of the bar 74, and terminates above the bar. The upper end portion 92 of the back link 90 is externally threaded.

A spring adjustment knob 94 is screwed on the threaded upper end portion 92 of the back link 90. The spring adjustment knot 94 has a cylindrical configuration with a closed top end and an open bottom end that is presented toward the block 60.

A spring cup 96 is fixed to the distal end of the bar 74 and thus is fixed for movement with the tee 70. The spring cup 96 has a cylindrical configuration with a closed bottom end and an open top end, presented toward the spring adjustment knob 94. The back link 90 extends freely through the spring cup 96 and can slide through the spring cup.

A coil spring 100 is located between the spring cup and the spring adjustment knob. The coil spring 100 is a compression spring that encircles the back link 90. The upper end of the spring 100 is received in the spring cup 96. The upper end of the spring 100 is received in the spring adjustment knob 94. As a result, the spring 100 is captured on the back link 90, between the spring cup 96 and the spring adjustment knob 94.

In use of the load assistance device 10, the gap in the actuator arm 20 is initially set, as described above. Also, the position of the spring adjustment knob 94 on the back link 90 is set. This position controls the point, in the soldier'stride, at which the spring 100 begins to be compressed. This setting also affects how much energy is stored in the spring 100. The stiffness of the spring 100 can also be selected to control this characteristic. This adjustment can also be used to compensate for different soldier strides, varying terrain conditions, varying loads, etc.

During the stride, when heel strike occurs and the plant phase commences (see FIGS. 6 and 6A), the jack spring 22 is actuated as described above to close the gap in the actuator arm 20. This closing of the gap enables transmission of backpack load in a downward direction, from the load receptor point 12, through the actuator arm 20 and the leg 40, into the tee 70. The backpack load is thereafter transmitted down from the tee 70, through the front link 76, into the block 60 and thence into the boot clamp 44. The backpack load is transmitted into the block 60 at the location of the forward pivot axis 66. This is a pinned (revolute) connection. The load from the block 60 is transmitted into soldier's boot 46 and thus to the ground. In this manner, at least some of the load that the soldier is carrying is transmitted to the ground rather than having to be borne by the soldier, for a time period starting with the point in the stride that is heel strike. As is well known, reducing the effective load being carried by the soldier is beneficial.

As the soldier thereafter strides forward, the soldier's leg and ankle roll forward while the sole of the foot stays on the ground (rollover phase) (see FIGS. 8 and 8A). The soldier's boot 46 and the boot clamp 44 stay in the same position on the ground, but the upper end of the device 10, including the load receptor point 12, moves forward relative to the ground and relative to the boot clamp 44. As a result, the device leg 40 pivots about the forward pivot axis 66 (in a clockwise direction as viewed in the drawings).

This pivoting movement of the leg 40 draws the tee 70 forward, relative to the block 60. As the tee 70 moves forward, the tee also pivots or twists in space about the forward pivot axis 66, and simultaneously draws the back link 90 forward. The back link 90, which extends with a slip fit through the bar 74 of the tee 70, pivots as it moves forward (in a clockwise direction as viewed in the Figures), about the rear pivot axis 68.

When the soldier then reaches the point in the stride at which the foot begins to lift off the ground (FIG. 8), the computer senses/determines this occurrence, via the tibial sensors 57, and opens the gap in the jack spring 22, thus ending the load transmission down from the backpack 14 to the foot.

As described below in detail, the presence and operation of the spring 100 in the ankle mechanism 42 enables the user of the device 10 to experience a much more comfortable and efficient stride. Specifically, the spring 100 is employed in the ankle mechanism to reduce the known “heel pinning” effect. This effect occurs when a relatively large load is being transmitted from the backpack 14 to the boot—in this case, at the location of the front pivot axis 66. This location is relatively close to the heel when needed during the stride, thus disturbing the soldier's normal gait by requiring additional muscle movements as compared to a normal, unencumbered, stride. Such additional muscle movements result in an awkward stride, earlier tiring of the soldier, and a decrease in metabolic efficiency.

The function and operation of the spring 100, as part of the ankle mechanism 42, are described in more detail next, in conjunction with FIGS. 6-11. Conceptually, the ankle mechanism 42 can be considered as a four bar mechanism, with its primary component being four rigid bars. The tee 70 can be considered as the first bar. The block 60 can be considered as the second bar. The tee 70 is connected to the block 60 by a revolute joint (J1-2) at the front pivot axis 66. The back link 90 can be considered as the third bar. The back link 90 is connected with the block 60 by a revolute joint (J2-3) at the back pivot axis 68. The spring cup 96 can be considered as the fourth bar. The spring cup 96 is connected with the back link 90 by a sliding joint (J3-4). The spring cup 96 is also connected with the tee 70 by a revolute joint (J4-1). And finally, the block 60 is rigidly connected to the sole of the boot 46, as described above.

FIGS. 5 and 5A illustrate the device 10, and the ankle mechanism 42, during the swing phase of the stride. The actuator arm 20 is open—that is, there is a gap between the spring 24 and the rod 26 of the jack spring 22—so that no force can be transmitted along the length of the actuator arm. The boot 46 is off the ground. The spring 100 is uncompressed. The other parts of the ankle mechanism 42 are in a first or unactuated condition as shown in FIG. 6A.

As the soldier walks with the device 10, just before heel strike of the right leg as shown in the figure, the soldier is free to extend his leg as quickly as he needs to without interference from the device 10, because (1) the actuator arm 20 is not engaged at this point so that no load is being transferred, and (2) the slip joint 84 between the leg 40 and the ankle mechanism 42 is open.

FIGS. 6 and 6A illustrate the device 10, and the ankle mechanism 42, during the heel strike phase of the stride. Upon heel strike, the leg 40 of the device 10 transfers load to the ground by closing the gap in the slip joint 84. At this point the soldier is carrying the remaining portion of the backpack load (the portion not being carried by the device 10) and that load is on the soldier's right heel as well.

The actuator arm 20 closes in response to sensing of the point in the gait that corresponds to heel strike, so that load from the backpack 14 can be transmitted along the length of the actuator arm to the leg 40. When the heel of the boot 46 strikes the ground, the spring 100 remains uncompressed. The other parts of the ankle mechanism 42 remain in the first or unactuated condition as shown in FIG. 6A.

The backpack load, as transmitted down through the leg 40 of the device 10, acts at the Joint J1-2 on the boot clamp. Joint J1-2 is close to the heel of the soldier, and therefore the soldier experiences the above-described “heel pinning effect” in which his heel is felt to be pinned to the ground.

FIGS. 7 and 7A illustrate the device 10, and the ankle mechanism 42, during the next phase of the stride, the “rollover” phase, when the soldier's lower leg begins to rotate about the ankle. The forward movement of the soldier's torso draws the device leg 40 forward, pivoting it about the front pivot axis 66. The tee 70 also pivots. As can be seen in FIG. 8A, when the tee 70 and the front link 76 pivot during the rollover segment of the stride, the distal end of the bar 74 of the tee 70 moves upward and forward relative do the block 60, which itself stays level on the ground with the soldier's foot.

As the distal end of the bar 74 moves upward, the spring cup 96 is pushed upward, sliding along the spring rod 90. Sufficient upward movement of the spring cup 96 in this direction eventually begins to compress the spring 100 against the spring adjustment knob 94.

As the tee 70 pivots clockwise, joint J3-4 moves up, and so does the spring cup 96, which causes the spring 100 to move up on the back link 90. When the spring 100 contacts the spring adjustment knob 94, and if the tee 70 thereafter continues to move in the clockwise direction, the spring starts to be compressed. At this point, joint J3-4 experiences resistance to upward movement. The more that the tee 70 continues to pivot in the clockwise direction, the more that the spring 100 compresses, providing greater resistance to upward movement of joint J3-4.

Thus, joint J3-4 is allowed to move freely until a certain point and then resistance is provided by the spring 100. This point can be adjusted by selectively positioning the spring adjustment knob 94 up and down on the back link 90. The goal of the adjustment is to allow the ankle mechanism 42 to move freely and provide no resistance at certain portions of the gait cycle (swing, heel strike, and stance phase), while providing resistance during the rollover phase of the gait cycle.

Without the ankle mechanism 42 including the spring 100, the load being carried by the leg 40 of the device 10 acts downward solely through joint J1-2, which is near the soldier's heel. This causes the heel to stay pinned to the ground and make it difficult for the soldier to walk. Instead, the ankle mechanism 42 of the present invention, used with the boot, causes the line of action to move forward from joint J1-2 towards the ball of the soldier's foot, minimizing the heel pinning effect and matching what the soldier's foot naturally does while walking. This makes it easier for the soldier to walk while using the device 10. This occurs as follows.

Before the rollover phase commences, the line of action for the load carried by the device 10 acts downward through joint J1-2 into the Block 60 and thence into the boot clamp 44, the boot 46, and the ground, and is denoted in FIGS. 10 and 11 as force F1, acting downward on the ground. An equal and opposite, upward acting, reaction force F2 is produced by the ground.

When the tee 70 moves clockwise during the rollover phase of the stride, the spring 100 compresses, producing a force F3 (spring compression force). An equal and opposite force F4 is generated which acts downward at joint J3-4. Because the tee 70 is connected at joint J3-4, this force F4 acts in a direction to twist (rotate) the tee 70 in space, counter-clockwise, about a center of rotation at joint J1-2. This force F4 acts on the device lower leg 40 at a distance illustrated by the arrow L1, creating a moment M1. moment M1 is centered on joint J1-2 and acts in a counter-clockwise direction (as viewed in the drawings). Thus, at the front of the block 60, moment M1 effectively creates a force that acts upward, because moment M1 is centered behind the front end of the block 60.

Since the moment M1 is applied at the front pivot axis 66, which is a pinned (revolute) joint J1-2, M1 has no actual rotational effect. Rather, the force M1 combines with the force F2 and produces a net ground force F5 that acts upward, at a point forward of the front pivot axis 66, by a distance equal to the length of the arrow L2, and thus forward of the nominal line of action F2.

Because the net ground force upward is located farther forward, the perceived line of action (net downward force), designated 110 in FIG. 11, moves forward. This forward movement of the line of action effectively reduces the portion of the load that is acting on the soldier's boot heel, thus reducing the heel pinning effect and making it more comfortable for the soldier to walk. Because the soldier does not have to exert the extra force of using muscles in a different manner to overcome the load, the soldier expends less energy in walking.

In sum, the ankle mechanism 42 including the spring 100 provides a heel lifting force that is a fixed distance in front of the normal line of action F1. Having the spring 100 located and acting behind the normal line of action F1 creates a moment are M1 in front of the normal line of action F1; this moves the effective line of action 110 forward and thus effectively reduces the heel pinning effect, making walking with an external load more comfortable and metabolically efficient. If the ankle mechanism 42 did not include the spring 100, the device 10 would not generate the moment M1, and the net resultant upward ground force would by only F2, which is too close to the heel to make extended walking feasible.

F2 is the reaction force from the weight being transmitted downward through the device 10, not from the weight of the soldier. Also, M1 is generated entirely from the spring 100 in the ankle mechanism 42, not from the soldier's ankle. Therefore, F5 is the resultant of F2 and M1 generated entirely from the device 10. There is also a ground reaction (similar to F2) generated by the soldier, a moment reaction (similar to M1) generated by the soldier's ankle, and therefore a resultant reaction (similar to F5) generated completely by the soldier. The device generated reactions are designed to be parallel to the soldier generated reactions. If the device reactions were mismatched physically in location and direction and magnitude with respect to the soldier reactions (that is, if the line of action did not approximately behave as it does for the soldier reactions), the soldier reactions would need to compensate in order to carry the entire mass. The more compensation is needed, the more uncomfortable and difficult it would be; that is, metabolic efficiency would be decreased.

From the above description of the invention, those skilled in the art will perceive improvements, changes and modifications in the invention. For example, a tension spring can be used instead of a compression spring. The tension spring would be connected between the block 60 and the tee 70. The compression spring can also be replaced with a tension cable that is tunable to provide more or less slack, for example, with movable connection points, or a turnbuckle. Either tension element can be made tunable in order to control the point of engagement of this tension member (just as the spring adjustment knob 94 is movable to control the point of engagement of the compression spring 100). Such improvements, changes and modifications within the skill of the art are intended to be covered by the appended claims.

1. A load assistance device wearable by a user carrying a mass on the user's torso, the device transmitting a portion of the load from the mass to the ground without that portion of the load passing through the user's legs and thereby reducing the effective load on the user, the device comprising:
a load receptor for receiving the load from the mass;
a boot clamp for transmitting the load to the user's boot; and
a linkage connected between the load receptor and the boot clamp, the linkage having a first or actuated condition in which the linkage transmits load downward from the load receptor into the boot clamp and having a second or unactuated condition in which the linkage does not transmit load downward from the load receptor into the boot clamp, the linkage moving between the first and second conditions in response to sensing of the user's gait;
the linkage including a slip joint between the load receptor and the boot clamp, the slip joint dividing the linkage into an upper linkage portion above the slip joint and a lower linkage portion below the slip joint;
the slip joint enabling the upper linkage portion and the lower linkage portion to move relative to each other between a first or engaged position in which the slip joint is closed and the upper linkage portion can transmit load downward to the lower linkage portion, to a second or disengaged position in which the slip joint is open and the upper linkage portion cannot transmit load downward to the lower linkage portion.

2. A device as set forth in claim 1 wherein the dimensions of the parts of the load assistance device including the slip joint are selected to place the slip joint in the disengaged condition, blocking downward transmission of load, at all points of the user's stride except during the stance phase of the stride.

3. A device as set forth in claim 2 wherein the device includes a downwardly projecting sleeve on the upper linkage portion and an upwardly projecting pin on the lower linkage portion, the sleeve having a slip fit on the pin to provide the slip joint of the device, the sleeve end bottoming out on the pin with the slip joint is in the engaged condition to provide a path of downward force transmission.

4. A device as set forth in claim 3 wherein the dimensions of the pin and the sleeve are selected so that the sleeve does not come completely off the pin during the user's stride, but so that the sleeve is easily removable from the pin to enable doffing of the load assistance device.

5. A device as set forth in claim 1 wherein the upper linkage portion includes two major sections that are pivotable relative to each other about a knee joint, with relative pivotal movement between the two major linkage sections being driven by the user not by the device, so that sensing of the user's gait is not used to control relative pivotal movement of the major linkage sections, and wherein the device is physically attached to the user in a downward load transmitting relationship only at the load receptor point and at the boot clamp.

6. A device as set forth in claim 5 including only a single powered actuator, the single powered actuator being used to control movement of the linkage between the first and second conditions in response to sensing of the user's gait.

7. A device or set forth in claim 1 wherein the boot clamp is fixed to the lateral and medial sides of the user's boot and has no portions that are disposed underneath the outsole of the user's boot between the outsole and the ground surface on which the user walks.

8. A device as set forth in claim 1 wherein the linkage includes a leg member disposed between the boot clamp and the load receptor, the linkage including an ankle mechanism connecting the boot clamp to the leg member for pivotal movement relative to the leg member about a first pivot axis when the user's boot is on the ground during a stride of the user, and the ankle mechanism includes a spring that acts between the boot clamp and the leg member and that is compressed during the rollover phase of the user's stride thereby to counteract the heel pinning effect of the device.

9. A device as set forth in claim 8 wherein the boot clamp is fixed to at least the lateral sides of the user's boot and having no portions that are disposed underneath the outsole of the user's boot between the outsole and the ground surface on which the user walks.

10. A load assistance device wearable by a user carrying a mass on the user's torso, the device transmitting a portion of the load from the mass to the ground without that portion of the load passing through the user's legs and thereby reducing the effective load on the user, the device comprising:
a load receptor for receiving the load of the mass;
a boot clamp for transmitting the load to the user's boot; and
a linkage connected between the load receptor and boot clamp, the linkage having a first or actuated condition in which the linkage transmits load downward from the load receptor into the boot clamp and having a second or unactuated condition in which the linkage does not transmit load downward from the load receptor into the boot clamp, the linkage moving between the first and second conditions in response to sensing of the user's gait;
the boot clamp being fixed to at least the lateral sides of the user's boot and having no portions that are disposed underneath the outsole of the user's boot between the outsole and the ground surface on which the user walks.

11. A device as set forth in claim 10 wherein the boot clamp is a single piece that extends from the lateral side of the boot outsole around the boot heel and to the medial side of the boot outsole, and that is fixed to the lateral and medial sides of the outsole with a plurality of fasteners.

12. A device as set forth in claim 11 wherein one of the plurality of fasteners that is located on the lateral side of the boot outsole defines a first pivot axis of the device, the linkage having an ankle mechanism that enables pivoting of a leg portion of the device relative to the boot clamp about the first pivot axis when the user is in the plant portion of the user's stride.

13. A device as set forth in claim 10 wherein the linkage includes a slip joint between the load receptor and the boot clamp, the slip joint dividing the linkage into an upper linkage portion above the slip joint and a lower linkage portion below the slip joint, the slip joint enabling the upper linkage portion and the lower linkage portion to move relative to each other between a first or engaged position in which the slip joint is closed and the upper linkage portion can transmit load downward to the lower linkage portion, to a second or disengaged position in which the slip joint is open and the upper linkage portion cannot transmit load downward to the lower linkage portion.

14. A device as set forth in claim 10 wherein the linkage includes a leg member disposed between the boot clamp and the load receptor, the linkage including an ankle mechanism connecting the boot clamp to the leg member for pivotal movement relative to the leg member about a first pivot axis when the user's boot is on the ground during a stride of the user, and the ankle mechanism includes a spring that acts between the boot clamp and the leg member and that is compressed during the rollover phase of the user's stride thereby to counteract the heel pinning effect of the device.

15. A device as set forth in claim 10 wherein the linkage includes a slip joint between the load receptor and the boot clamp, the slip joint dividing the linkage into an upper linkage portion above the slip joint and a lower linkage portion below the slip joint, the slip joint enabling the upper linkage portion and the lower linkage portion to move relative to each other between a first or engaged position in which the slip joint is closed and the upper linkage portion can transmit load downward to the lower linkage portion, to a second or disengaged position in which the slip joint is open and the upper linkage portion cannot transmit load downward to the lower linkage portion.

16. A load assistance device wearable by a user carrying a mass on the user's torso, the device transmitting a portion of the load from the mass to the ground without that portion of the load passing through the user's legs and thereby reducing the effective load on the user, the device comprising:
a load receptor for receiving the load;
a boot clamp for transmitting the load to the user's boot; and
a linkage connected between the load receptor and the boot clamp, the linkage having a first or actuated condition in which the linkage transmits load downward from the load receptor into the boot clamp and having a second or unactuated condition in which the linkage does not transmit load downward from the load receptor into the boot clamp, the linkage moving between the first and second conditions in response to sensing of the user's gait;
the linkage including a leg member disposed between the boot clamp and the load receptor;
the linkage including an ankle mechanism connecting the boot clamp to the leg member for pivotal movement relative to the leg member about a first pivot axis when the user's boot is on the ground during a stride of the user; and
the ankle mechanism including a spring that acts between the boot clamp and the leg member and that is compressed during the rollover phase of the user's stride thereby to counteract the heel pinning effect of the device.

17. A device as set forth in claim 16 wherein the spring is located behind the first pivot axis of the device and when compressed produces a resultant ground force that acts upward on the user's boot at a location forward of the first pivot axis of the device thereby to counteract the heel pinning effect of the device.

18. A device as set forth in claim 17 wherein the first pivot axis is located at a revolute joint that connects the boot clamp with the leg member, and the spring when compressed produces a moment that is centered on the first pivot axis and that creates a force that constitutes a portion of the resultant ground force.

19. A device as set forth in claim 16 wherein the linkage mechanism includes a block that is fixed to the boot clamp and on which is located the first pivot axis, and wherein the spring when compressed produces a resultant force that acts generally downward on the block at a location behind the first pivot axis, thereby producing a moment that creates a force that acts generally upward in front of the first pivot axis.

20. A device as set forth in claim 16 wherein the linkage includes a slip joint between the load receptor and the boot clamp, the slip joint dividing the linkage into an upper linkage portion above the slip joint and a lower linkage portion below the slip joint, the slip joint enabling the upper linkage portion and the lower linkage portion to move relative to each other between a first or engaged position in which the slip joint is closed and the upper linkage portion can transmit load downward to the lower linkage portion, to a second or disengaged position in which the slip joint is open and the upper linkage portion cannot transmit load downward to the lower linkage portion.

21. A device as set forth in claim 16 wherein the boot clamp is fixed to the lateral and medial sides of the user's boot and has no portions that are disposed underneath the outsole of the user's boot between the outsole and the ground surface on which the user walks.

22. A device as set forth in claim 21 wherein the boot clamp is fixed to the lateral and medial sides of the user's boot and has no portions that are disposed underneath the outsole of the user's boot between the outsole and ground surface on which the user walks.

23. A load assistance device wearable by a user carrying a mass on the user's torso, such as a backpack, the device transmitting a portion of the load from the mass to the ground without that portion of the load passing through the user's legs and thereby reducing the effective load on the user, the device comprising:
a load receptor for receiving load from the mass;
a boot clamp for transmitting the load to the user's boot; and
a linkage connected between the load receptor and the boot clamp, the linkage having an actuated condition in which the linkage transmits load downward from the load receptor into the boot clamp and having an unactuated condition in which the linkage does not transmit load downward from the load receptor into the boot clamp;
at least one sensor for sensing the user's stride: and
a computer responsive to the at least one sensor for controlling movement of the linkage between the actuated and unactuated conditions in response to sensing of the user's stride, the linkage being moved into the actuated condition upon sensing of the commencement of the stance phase of the user's stride and being moved into the unactuated condition in response to sensing of the heel lift phase of the user's stride.

24. A load assistance device as set forth in claim 23 wherein the linkage includes an actuator arm that includes two adjacent members that are engaged with each other when the linkage is in the actuated condition thereby to enable load transmission from the load receptor to the boot clamp and that are separated from each other with a gap between them when the linkage is in the unactuated condition thereby to break the path of load transmission from the load receptor to the boot clamp.

25. A load assistance device as set forth in claim 24 including an electric actuator motor controlled by the computer for moving one of the two adjacent members relative to the other member thereby to open and close the gap between them.

26. A device as set forth in claim 25 wherein the linkage includes an arm section and a leg section that are pivotable relative to each other about a knee joint, with relative pivotal movement between the two linkage sections being driven by the user not by the device, so that sensing of the user's stride is not used to control relative pivotal movement of the linkage sections, and wherein the device is physically attached to the user in a downward load transmitting relationship only at the load receptor point and at the boot clamp.

27. A device as set forth in claim 25 including wherein the electric actuator motor is the only powered actuator in the load assistance device.

28. A device as set forth in claim 23 wherein the actuator arm includes a jack spring.
